(19) United States
(12) Patent Application Publication
(10) Pub. No.: US 2006/0093133 A1
(43) Pub. Date: May 4, 2006

(54) Portable terminal having combination of optical waveguide and sound resonance space

(75) Inventors: Jun-Sang Park, Anyang-si (KR); In-Gon Park, Seoul (KR); Chang-Soo Lee, Bupyeong-gu (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Gyeonggi-do (KR)

(21) Appl. No.: 11/245,516

(22) Filed: Oct. 7, 2005

(30) Foreign Application Priority Data
Nov. 2, 2004 (KR) 2004-88317

(51) Int. Cl. H04M 1/00; H04M 9/00

(52) U.S. Cl. 379/433.12

(57) ABSTRACT

Disclosed is a portable terminal having a combination of an optical waveguide and a speaker sound resonance space. The portable terminal includes a main housing; a sliding housing adapted to be opened from and closed on the main housing; an opening positioned between the main housing and the sliding housing, the opening having at least one open end positioned at the entrance thereof and at least one closed end to define a predetermined space and providing an optical waveguide and a sound resonance space toward the open end; an optical system positioned on the chosen closed end to provide the optical waveguide with an optical source; and a speaker device positioned to face the optical system for emitting sound to the sound resonance space.

### PRIORITY

This application claims priority to an application entitled “Portable Terminal Having Combination of Optical Waveguide and Sound Resonance Space” filed with the Korean Intellectual Property Office on Nov. 2, 2004 and assigned Serial No. 2004-88317, the contents of which are incorporated herein by reference.

### BACKGROUND OF THE INVENTION

1. Field of the Invention

The present invention relates to portable terminals including cellular phones, PDAs (Personal Digital Assistants), HHPs (Hand Held Phones), camera phones, game phones, and Internet phones, and more particularly to a portable terminal having a combination of an optical waveguide for an optical source and a speaker sound resonance structure.

2. Description of the Related Art

In general, a “portable communication apparatus” refers to an electronic apparatus which a user can carry with him to perform wireless communication with a desired partner. To facilitate portability, designs of such portable communication apparatuses tend not only to be compact, slim, and light, but are also moving toward providing multimedia availability, having a wider variety of functions. In particular, future portable communication apparatuses are expected to incorporate greater multi-functionality and be capable of multi-purpose utilization, as well as to be more compact, light, and capable of being modified to be suitable for various multimedia environments or Internet environments. Additionally, portable communication apparatuses are now commonly used by people of all ages and all walks of life throughout the world, and are recognized by some people as a nearly indispensable commodity which must be carried all the time.

A portable communication apparatus may be classified into various categories according to its appearance, such as a bar-type portable communication apparatus, a flip-type portable communication apparatus, and a folder-type portable communication apparatus. The bar-type communication apparatus has a single housing shaped like a bar. The flip-type communication apparatus has a flip rotatably coupled to a bar-shaped housing by a hinge device. The folder-type communication apparatus has a folder connected to a single bar-shaped housing by a hinge device in such a manner that the folder can be rotated to fold on or unfold from the housing.

Portable communication apparatuses may also be classified into a neck wearable type communication apparatus and a wrist wearable type communication apparatus according to the position at or the way in which a user puts on the communication apparatus. The neck wearable type communication apparatus is worn around the user's neck using a string, and the wrist wearable type communication apparatus is worn around the user's wrist.

In addition, portable communication apparatus may be classified into a rotation-type communication apparatus and a sliding-type communication apparatus according to the manner of opening and closing the communication apparatus. In the rotation-type portable communication apparatus, two housings are coupled to each other in such a manner that one housing rotates to be opened or closed relative to the other while they face each other. In the sliding-type portable communication apparatus, two housings are coupled to each other in such a manner that one housing slides along a longitudinal direction to be opened or closed relative to the other housing. These variously classified portable communication apparatuses can be easily understood by those skilled in the art.

Meanwhile, conventional portable communication apparatuses now tend to transmit data at a high speed in addition to performing the basic voice communication function. In other words, according to the increase in consumers demand, portable communication apparatuses now tend to provide a service using a wireless communication technology capable of transmitting data at a high speed.

Recent portable communication apparatuses also tend to be equipped with a camera lens to obtain video signals for transmission. In other words, current portable communication apparatuses have an external or embedded camera lens module which enables a user to perform video communication with a desired partner or to photograph a desired subject.

However, conventional sliding-type portable terminals are not provided with a lighting device for use at night or a separate structure for resonating sound from a speaker, and fail to meet these objects of lighting or sound resonance in a portable terminal that is convenient to use. If a portable terminal is equipped with a separate lighting device, the aesthetic view of the portable terminal deteriorates. If a portable terminal is equipped with a separate resonance device for resonating sound from a speaker, the aesthetic view and the portability of the portable terminal deteriorate.

When a separate accessory for a function in addition to the basic function must be separately purchased and mounted on the body of a portable terminal, the economic merit and aesthetic view of the portable terminal deteriorate, and the portability thereof degrades drastically. If a conventional portable terminal is separately equipped with a lighting device or a sound resonance device, the body of the terminal becomes bulky and the aesthetic view and portability thereof deteriorate. Therefore, the present invention seeks to provide a structure which combines a lighting function with a sound resonance function, as additional functions integrally provided in the portable terminal.

### SUMMARY OF THE INVENTION

Accordingly, the present invention has been made to solve the above-mentioned problems occurring in conventional systems, and an object of the present invention is to provide a portable terminal having a combination of an optical waveguide and a speaker sound resonance space.

Another object of the present invention is to provide a portable terminal having an opening, an optical system, and a reflection window to provide dim light and to improve the sound resonance structure.

Still another object of the present invention is to provide a portable terminal which can be used as a lighting device at night.

In order to accomplish this object, there is provided a portable terminal including a main housing; a sliding housing adapted to be opened from and closed on the main housing; an opening positioned between the main housing and the sliding housing, the opening having at least one open end positioned at the entrance thereof and at least one closed end to define a predetermined space and providing an optical waveguide and a sound resonance space toward the open end; an optical system positioned on the chosen closed end to provide the optical waveguide with an optical source; and a speaker device positioned to face the optical system for emitting sound to the sound resonance space.

In accordance with another aspect of the present invention, there is provided a portable terminal including a housing; an opening positioned in a predetermined position on the housing, the opening having at least one open end positioned at the entrance thereof and at least one closed end to define a predetermined space and providing an optical waveguide and a sound resonance space toward the open end; an optical system positioned on the chosen closed end to provide the optical waveguide with an optical source; and a speaker device positioned to face the optical system for emitting sound to the sound resonance space.

### BRIEF DESCRIPTION OF THE DRAWINGS

The above and other objects, features and advantages of the present invention will be more apparent from the following detailed description taken in conjunction with the accompanying drawings, in which:

FIGS. 1 and 2 are perspective views showing a portable terminal equipped with a combination of an optical waveguide for an optical source and a speaker sound resonance structure according to the present invention;

FIG. 3 is a front view of the portable terminal shown in FIG. 1;

FIG. 4 is a perspective view showing a portable terminal, with its sliding housing completely open, according to the present invention;

FIG. 5 is an end view showing a portable terminal equipped with a combination of an optical waveguide and a sound resonance structure according to the present invention; and

FIG. 6 is a partially-broken side sectional view showing a combination of an optical waveguide and a sound resonance structure according to the present invention.

### DETAILED DESCRIPTION OF THE PREFERRED EMBODIMENTS

Hereinafter, preferred embodiments of the present invention will be described with reference to the accompanying drawings. In the following description of the present invention, a detailed description of known functions and configurations incorporated herein is omitted to avoid making the subject matter of the present invention unclear.

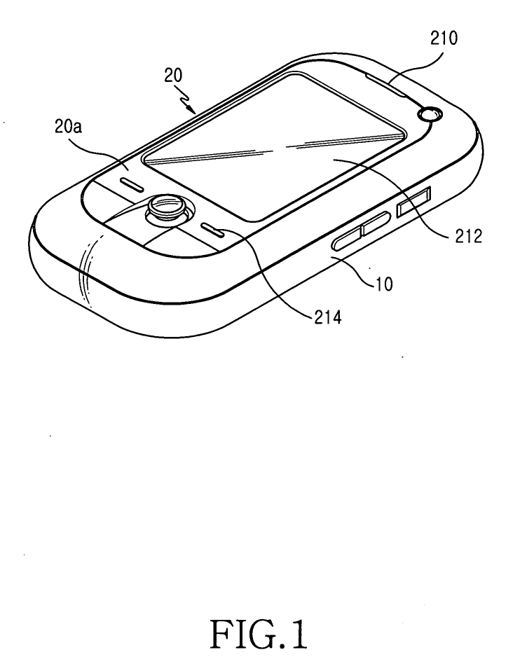

It must be noted that, although the combination of an optical waveguide and a sound resonance structure according to the present invention is shown to be applied to a sliding-type portable terminal in FIGS. 1 and 2, it can be equally used for the body of all kinds of portable terminals including bar-type, flip-type, folder-type, and swing-type portable terminals, without limitation. In addition, the optical system used for the portable terminal according to the present invention can be used not only as a lighting device at night, but also as lamp to signal incoming calls. This is accomplished because light from the LED is being illuminated as dim light in the opening by the reflection plate.

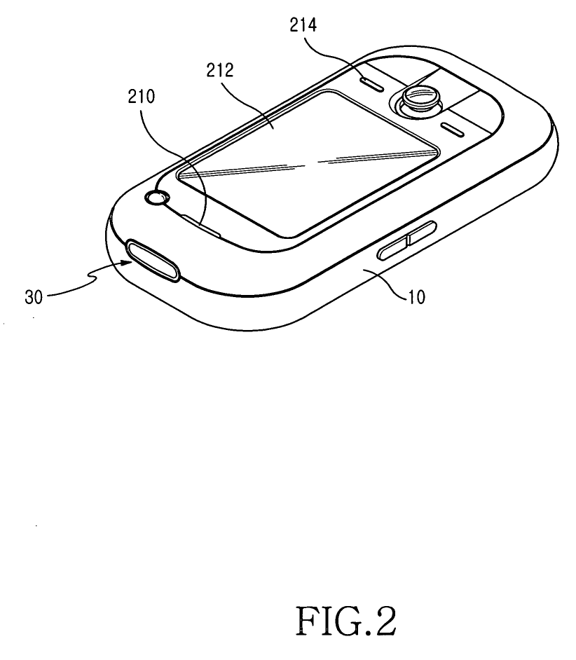

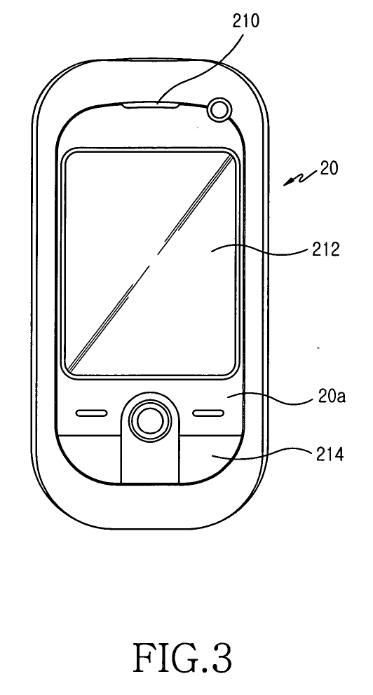

The portable terminal shown in FIGS. 1 to 4 is a sliding-type portable terminal and includes a main housing 10 and a sliding housing 20 adapted to slide linearly on the top surface 10a of the main housing 10, for opening and closing. The main housing 10 has a number of first keys 110 and a microphone device 112 positioned on the top surface 10a thereof. The sliding housing 20 has a first speaker device 210, a display device 212, and second keys 214 positioned on the top surface 20a thereof. The first keys 110 and the microphone device 112 are position adjacent to each other. The first speaker device 210, the display device 212, and the second keys 214 are positioned adjacent to one another. The first keys 110 are exposed or hidden according to whether the sliding housing 20 is slid open or closed, while the second keys 214 are always exposed. Referring to FIG. 4, the first and second keys 110 and 214 are positioned adjacent to each other when the sliding housing 20 is completely open from the main housing 10.

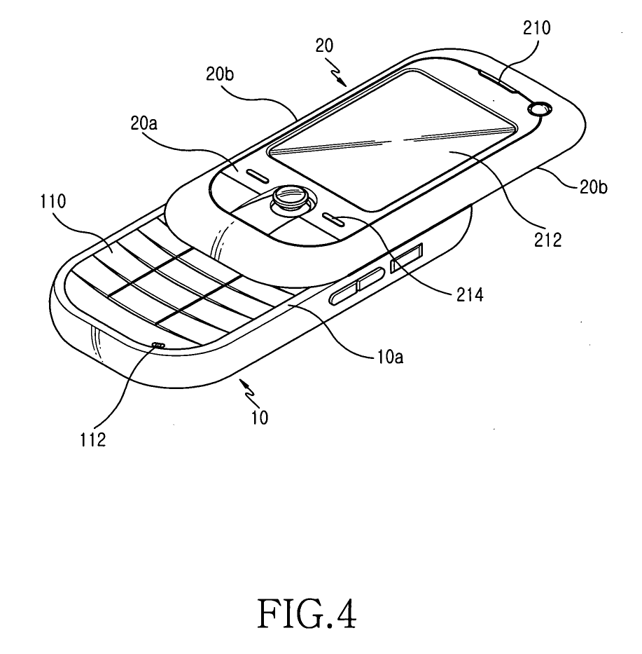

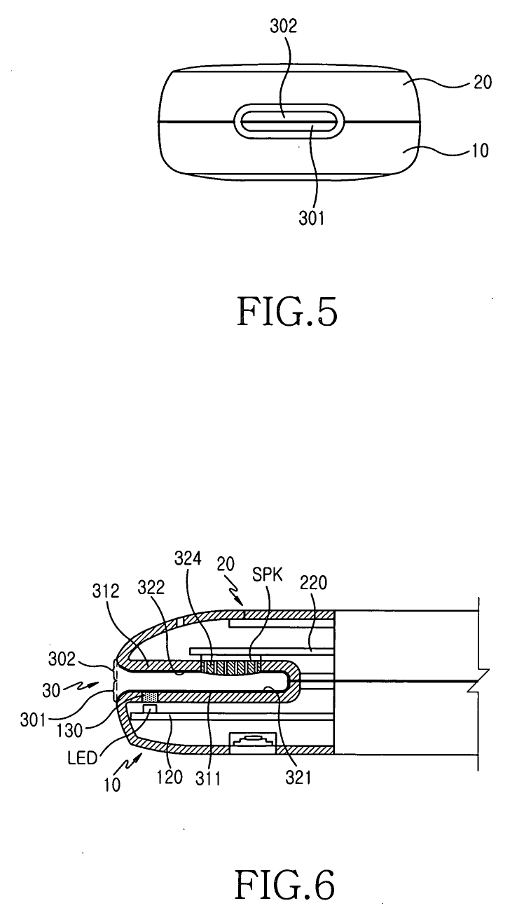

The construction of a combination of an optical waveguide and a sound resonance structure applied to a portable terminal according to the present invention will now be described with reference to FIGS. 5 and 6.

As shown in FIGS. 5 and 6, the combination of an optical waveguide and a sound resonance structure applied to a portable terminal according to the present invention includes an opening 30 positioned between the main housing 10 and the sliding housing 20 that functions as both an optical waveguide and a sound resonance structure, an optical system contained in the opening 30, and a second speaker SPK positioned to face the optical system.

More particularly, the combination of an optical waveguide and a sound resonance structure according to the present invention includes an opening 30 having at least one open end 301 and 302 positioned at the entrance thereof and at least one closed end 311 and 312 to define a predetermined space for providing an optical waveguide and a sound resonance space toward the open end 301 and 302, an optical system positioned on closed end 311 to provide the optical waveguide with an optical source, and a second speaker device SPK for emitting sound into the sound resonance space.

The optical system includes an LED connected to a PCB 120 positioned on the main housing 10 and a window 130 positioned in a predetermined region on closed end 311 with a surface thereof exposed and adapted to guide light emitted from the LED into the opening 30. The window 130 preferably functions as a waveguide for light emitted from the LED and may be made up of a transparent window, a semi-transparent window, a lens, or a window having a color added thereto. The optical system further includes reflection windows 321 and 322 positioned on the closed ends 311 and 312 of the opening to reflect the light guided via the window 130 and provide a resonance space for the emitted sound. As such, the light guided by the reflection windows 321 and 322 via the window 130 is guided to the open ends 301 and 302, and the sound emitted from the second speaker device SPK is resonated by the opening 30 and is directed to the open ends 301 and 302.

The optical system is preferably used as an incoming call lamp or a lighting device. However, it is preferable to position the optical system on the rear end of the main housing 10 and use as a lighting device in the present invention.

The open ends include a first open end 301 positioned on the rear surface of the main housing 10 and a second open end 302 positioned on the rear surface of the sliding housing 20. The first and second open ends 301 and 302 spatially communicate each other when the sliding housing 20 is closed on the main housing 10 and provide an exit of the optical waveguide and the sound resonance space. The closed ends 311 and 312 include a first closed end 311 positioned on the rear portion of the top surface of the main housing 10 and a second closed end 312 positioned on the rear portion of the bottom surface 20a of the sliding housing 20. The first and second closed ends 311 and 312 face each other and provide a closed space when the sliding housing 20 is closed on the main housing 10 and delimit the optical waveguide and the sound resonance space.

When the sliding housing 20 is completely open from the main housing 10, as shown in FIG. 4, the first closed end 311 delimits a closed space together with the bottom surface 20a of the sliding housing and the light emitted from the LED is directed to the first open end 301 by the bottom surface 20a as a reflection plate. Of course, the sound emitted from the second speaker SPK is directly emitted to the exterior.

Preferably, the optical system (LED and window) is positioned near the first open end 301 and the second speaker SPK is positioned opposite to the optical system. Particularly, the second speaker SPK is positioned near the closed end in the deepest place of the opening 30. This is for the purpose of maximizing the resonance effect of the second speaker.

Reference numeral 324 in FIG. 6 refers to a speaker cover. The speaker cover has a number of holes through which the sound emitted from the second speaker SPK passes.

Preferably, the closed ends 311 and 312 of the opening provide reflection windows 321 and 322 composed of reflection layers that have and perform a mirror function. This is for the purpose of collecting and guiding energy emitted from the optical source and providing the user with dim light when the light emitted from the LED is reflected by the reflection layers 321 and 322 and is emitted to the exterior via the open ends 301 and 302.

As mentioned above, a portable terminal equipped with a combination of an optical waveguide and a sound resonance structure according to the present invention provides dim light and more improved sound. Particularly, the portable terminal can be used as a lighting device at night. While the invention has been shown and described with reference to certain preferred embodiments thereof, it will be understood by those skilled in the art that various changes in form and details may be made therein without departing from the spirit and scope of the invention as defined by the appended claims. For example, the present invention can be applied not only to sliding-type portable terminals having two housings, but also to those having a single housing.

What is claimed is:

1. A portable terminal comprising:
a main housing;
a sliding housing adapted to be opened from and closed on the main housing;
an opening positioned between the main housing and the sliding housing, the opening having at least one open end at an entrance thereof and at least one closed end to define a predetermined space and providing an optical waveguide and a sound resonance space;
an optical system positioned on the closed end to provide the optical waveguide with an optical source; and
a speaker device facing the optical system for emitting sound into the sound resonance space.

2. The portable terminal as claimed in claim 1, wherein the optical system comprises an LED positioned on the main housing and a window positioned in a predetermined region on the closed end with a surface to guide light emitted from the LED into the opening.

3. The portable terminal as claimed in claim 2, wherein the window is made up of one of a transparent window, a semi-transparent window, a lens, or a window having a color added thereto.

4. The portable terminal as claimed in claim 2, wherein the window is an optical waveguide.

5. The portable terminal as claimed in claim 1, wherein the optical system further comprises a reflection window positioned on the opening to reflect guided light and provide resonance of emitted sound, the light guided by the reflection window via the window is guided toward the open end, and the sound emitted from the speaker device is directed toward the open end.

6. The portable terminal as claimed in claim 1, wherein the optical system is a lighting device.

7. The portable terminal as claimed in claim 5, wherein the reflection window is a mirror.

8. The portable terminal as claimed in claim 1, wherein the open end comprises a first open end positioned on a rear surface of the main housing and a second open end positioned on a rear surface of the sliding housing and the first and second open ends spatially communicate with each other when the sliding housing is closed on the main housing and provide an exit of the optical waveguide and the sound resonance space.

9. The portable terminal as claimed in claim 1, wherein the closed end comprises a first closed end positioned on a rear portion of a top surface of the main housing and a second closed end positioned on a rear portion of a bottom surface of the sliding housing and the first and second closed ends face each other and provide a closed space when the sliding housing is closed on the main housing to delimit the optical waveguide and the sound resonance space.

10. The portable terminal as claimed in claim 9, wherein the first closed end delimits a closed space together with the bottom surface of the sliding housing when the sliding housing is opened from the main housing and the sound emitted from the speaker device is directly emitted.

11. The portable terminal as claimed in claim 1, wherein the optical system is positioned near the open end and the speaker device is positioned on an opposite side of the optical system.

12. A portable terminal comprising:
a housing;
an opening positioned in a predetermined position on the housing, the opening having at least one open end at an entrance thereof and at least one closed end to define a predetermined space and providing an optical waveguide and a sound resonance space;
an optical system positioned on the closed end to provide the optical waveguide with an optical source; and
a speaker device facing the optical system for emitting sound into the sound resonance space.

13. The portable terminal as claimed in claim 12, wherein the opening is positioned on a rear surface of the housing.

14. The portable terminal as claimed in claim 12, wherein the optical system further comprises a reflection window positioned on the closed end to reflect guided light and provide resonance of emitted sound, the light guided by the reflection window via the window is guided toward the open end, and the sound emitted from the speaker device is directed toward the open end.

15. A method for providing an optical waveguide and a sound resonance space in a portable terminal, the method comprising:
positioning an opening between a main housing and a sliding housing of the portable terminal,
defining a predetermined space by providing the opening with at least one open end and at least one closed end; and
providing an optical waveguide and a sound resonance space in the predetermined space, with an optical system and a speaker device in the predetermined space for providing an optical source and for emitting sound, respectively.
